(19) United States
(12) Patent Application Publication
(10) Pub. No.: US 2025/0110969 A1
(43) Pub. Date: Apr. 3, 2025

(54) SYSTEM AND METHOD FOR CONSENSUS IN A SHARDED DISTRIBUTED LEDGER

(71) Applicant: Omar Syed, Murphy, TX (US)

(72) Inventor: Omar Syed, Murphy, TX (US)

(21) Appl. No.: 18/479,705

(22) Filed: Oct. 2, 2023

(51) Int. Cl. G06F 16/27; G06F 16/23

(52) U.S. Cl. CPC G06F 16/275; G06F 16/2343

(57) ABSTRACT

According to an aspect of the present invention, there is provided a sharded distributed ledger system that employs a network of peer-to-peer replicated state machines. These machines process incoming transactions to update a local copy of the data, ensuring that all participating computers maintain a synchronized copy of said data. The disclosed method enables transactions to be processed independently, without the need for batching or electing a leader to determine transaction processing order. This consensus algorithm is particularly advantageous in networks where data is sharded among computers. Consequently, the consensus mechanism ensures that all computers within a specific shard group maintain a synchronized copy of the corresponding partial data.

### BACKGROUND

Traditional consensus algorithms, including classical and Nakamoto consensus algorithms, process transactions in batches called blocks to enhance efficiency. While these methods reduce the need for individual transaction consensus, they introduce complexities in sharded networks. State sharding is a technique employed in distributed networks to improve scalability by dividing the data stored by all computers into smaller partitions called shards, and distributing the data among various computers; also referred to as nodes. Each shard manages its own data, facilitating parallel transaction processing. For example, US20210240733, Partitioning in a Blockchain Network, discloses a computer-implemented method of partitioning a blockchain network into shards, the method comprising: identifying a transaction id of a blockchain transaction; and allocating the transaction to a shard based on the transaction id.

However, challenges arise for consensus algorithms in sharded networks when transactions update data across multiple shards. Computers within each shard must reach consensus regarding their shard's data, while also ensuring consistency across all shards in terms of processed transactions. Transactions updating data in multiple shards must be applied uniformly to all relevant shards. This necessitates coordination and communication between shards, further complicating transaction validation and block creation processes, as multiple shard states must be considered.

Sharded networks traditionally process multi-shard transactions sequentially, moving from one shard to the next for further processing. This method increases transaction processing time proportionally to the number of involved shards. Moreover, if a transaction fails in any shard, it must be rolled back and fail in all other shards, adding to the complexity of transaction processing in sharded networks.

For example, U.S. Pat. No. 10,740,733, Sharded Permissioned Distributed Ledgers, discloses a sharded, permissioned, distributed ledger system, comprising: a plurality of computing devices configured to participate as a plurality of nodes in the distributed ledger system, wherein the plurality of nodes is configured to maintain a distributed ledger comprising a plurality of ledger shards configured to store information regarding one or more transactions; wherein each node comprises: one or more verifier services, configured to participate according to a consensus protocol to append information regarding individual transactions to individual ones of the plurality of ledger shards; and a dispatcher service configured to: receive a transaction request from a client, wherein the transaction request comprises information indicating a particular transaction and a target shard of the plurality of ledger shards, wherein the transaction is directed to the target shard; and forward the received transaction request to one of the verifier services associated with the target shard indicated in the transaction request.

Prior art methods suffer from significant limitations. An improved method for processing transactions in sharded networks without increased latency or rollback requirements for failed transactions is desirable.

### SUMMARY

In view of the above circumstances, the aspects of present invention discloses a system and method for a network of peer-to-peer computers to process transactions independently without aggregating them into blocks or other data structures.

The computers reach consensus on transaction processing order without requiring a leader. This approach optimizes parallel transaction processing, allowing transactions updating data across multiple shards to be executed simultaneously, without increased latency compared to single-shard transactions.

Upon receipt by the network, transactions are routed to the appropriate computers storing the data to be updated. Transactions are placed in a waiting queue ordered by their associated timestamps for a specified duration before processing, ensuring correct order even for out-of-sequence transactions. Any required data not locally stored by the computer is obtained from relevant remote computers.

Transactions are executed in a sandbox to determine the new state, with computers gossiping the resulting state as a vote to establish if a supermajority agrees on the outcome. By gathering votes from other computers, each computer independently creates a receipt proving supermajority agreement on the result state. This receipt serves as the basis for committing the transaction and updating the locally stored data.

In the event that a computer misses votes and fails to create a receipt, the receipt can be presented to the computer, allowing it to commit to the transaction and synchronize its data to match other computers.

### BRIEF DESCRIPTION OF THE DRAWINGS

FIG. 1 illustrates an algorithm according to an embodiment of the present invention.

FIG. 2 illustrates a schematic representation of a network of peer-to-peer computers, where different subsets of computers participate in various shards and store distinct portions of the complete data.

FIG. 3 depicts a transaction that updates data in two shards being routed to the subset of computers that store the data needed by the transaction.

FIG. 4 demonstrates the transaction being placed in a waiting queue, along with other transactions, based on timestamp order until it is ready for further processing.

FIG. 5 provides a schematic illustration of computers collecting data necessary for the transaction from remote computers.

FIG. 6 exhibits a computer executing the transaction in a sandbox to determine the new state.

FIG. 7 represents a schematic illustration of computers gossiping a vote on the transaction result to other computers processing the same transaction and collecting votes to form a receipt.

FIG. 8 shows a schematic illustration of two computers gossiping the transaction receipt and committing the transaction by updating the locally stored data.

### DETAILED DESCRIPTION

Embodiments illustrative of the present invention will be described with reference to the attached drawings. Note that constituents denoted by the same symbols have the same or similar configurations in respective figures.

The present invention relates to processing transactions in a sharded distributed ledger system employing a network of peer-to-peer computers with each computer having local storage and storing a subset of the complete data. The data stored by the network is divided into shards and different computers may hold different subsets of the complete data. Shards being defined as the subset of computers that store the same data. The computers are connected to a network and can send and receive messages using a communications protocol. Each computer is expected to have one or more processing units and necessary software in order to process transactions according to the method of the present invention.

While the present invention is illustrated using a network of computers with sharded data, such that no computer stores the complete data, the invention can also be applied to networks where data is not sharded, and each computer stores the complete data.

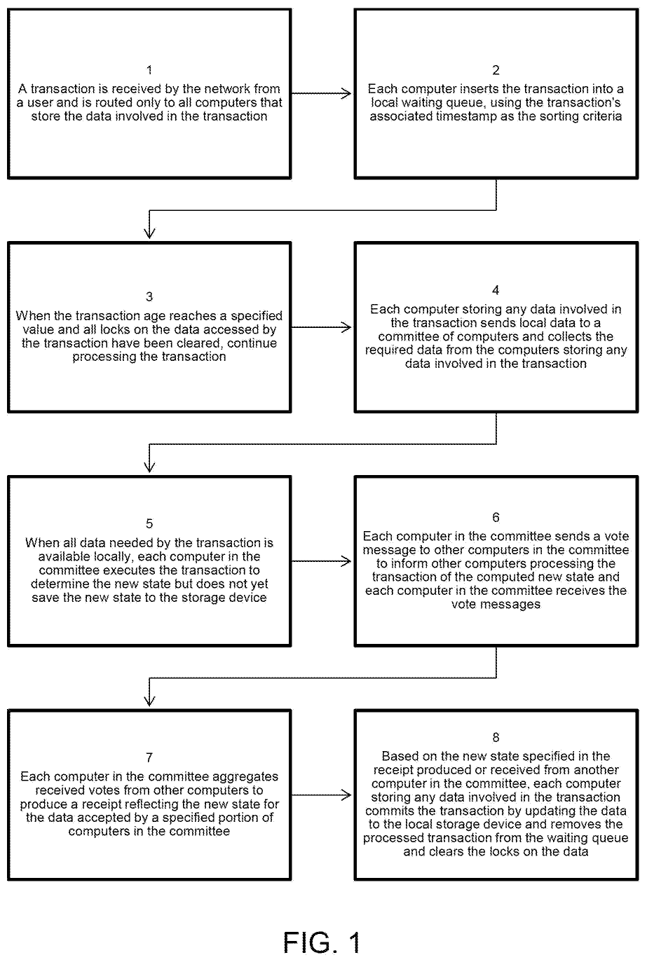

FIG. 1 illustrates the steps for processing a transaction in a sharded network according to an embodiment.

The first step 1, a transaction is received by the network from a user and is routed only to all computers that store the data involved in the transaction using a communication protocol such as gossip. Other embodiments of communication protocols such as a direct message transfer protocol or a broadcast protocol may be used instead of a gossip protocol.

In the second step 2, each computer inserts the transaction into a local waiting queue implemented in a storage device associated with each computer storing any data involved in the transaction, using the transaction's associated timestamp as the sorting criteria. In some embodiments the storage device may be a volatile memory or a persistent disk associated with the computer. In some embodiments the waiting queue may be implemented as a data structure such as a sorted array or a sorted tree. In some embodiments the sorting criteria may be a fee associated with the transaction or a proof of work associated with the transaction instead of or in addition to the timestamp associated with the transaction.

In the third step 3, when the transaction age, defined as the difference between the current timestamp on the computer and the transaction timestamp, reaches a specified value and all locks on the data accessed by the transaction have been cleared, continue processing the transaction in order based on the sorting criteria after locking the data accessed by the transaction.

In the fourth step 4, each computer storing any data involved in the transaction sends local data to a committee of computers encompassing a subset of computers in the network and the committee of computers collect the required data from the computers storing any data involved in the transaction. In some embodiments the committee of computers may be a subset of the computers storing any data involved in the transaction. In some embodiments the committee of computers may include all computers storing any data involved in the transaction.

In the fifth step 5, when all data needed by the transaction is available locally, each computer in the committee executes the transaction to determine the new state but does not yet save the new state to the storage device. The new state is used to create a vote message.

In the sixth step 6, each computer in the committee sends via a communication protocol a vote message to other computers in the committee to inform other computers processing the transaction of the computed new state. Each computer in the committee receives via a communication protocol, vote messages from other computers in the committee.

In the seventh step 7, each computer in the committee aggregates received votes from other computers to produce a receipt reflecting the new state for the data accepted by a specified portion of computers in the committee. In some embodiments a specified portion may be a percentage greater than 50%. The computers in the committee send via communication protocol the receipt to each computer storing any data involved in the transaction.

In the eighth step 8, based on the new state specified in the receipt produced or received from another computer in the committee, each computer storing any data involved in the transaction commits the transaction by updating the data to the local storage device. Each computer storing any data involved in the transaction then removes the processed transaction from the waiting queue and clears the locks on the data.

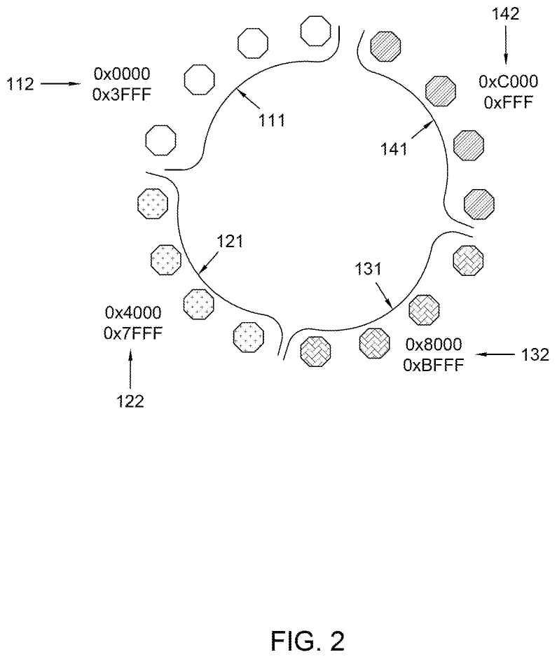

FIG. 2 illustrates a network of 16 computers where the data is partitioned into 4 shards. In this example, it is assumed that the data can be addressed by two bytes, with the address expressed in hexadecimal ranging from 0x0000 to 0xFFFF. However, the invention is not limited to this address range and can be applied to any address range. Computers in shard 111 store all data in range 112, specifically from 0x0000 to 0x3FFF. Similarly, computers in shards 121, 131, and 141 store data in ranges 122, 132, and 142, respectively. The invention can be applied with a different number of computers, a different number of shards and a different number of computers per shard. Moreover, the invention can be applied even if shard boundaries overlap and some computers belong to multiple shards.

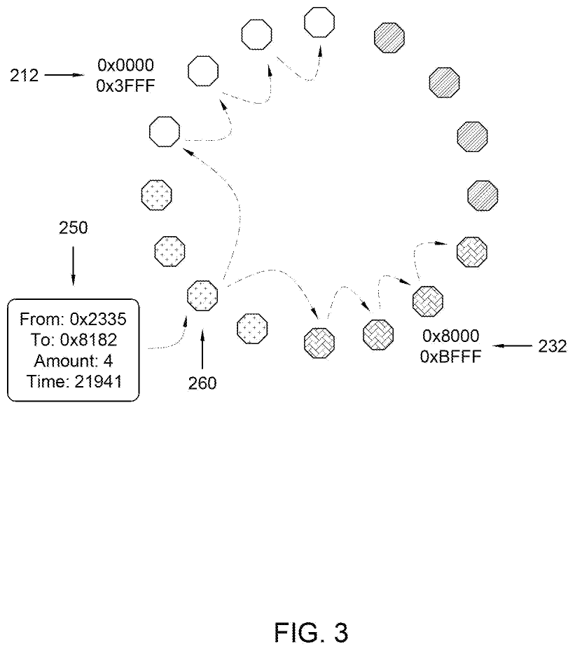

FIG. 3 corresponds to step 1 of the method outlined earlier. An incoming transaction is routed only to computers that store data involved in the transaction. Transaction 250 can be received by any computer 260 in the network and is passed on to the computers storing the data for addresses 0x2345 and 0x8182 involved in the transaction. While a gossip algorithm can be employed to distribute the transaction to computers storing the relevant address ranges.

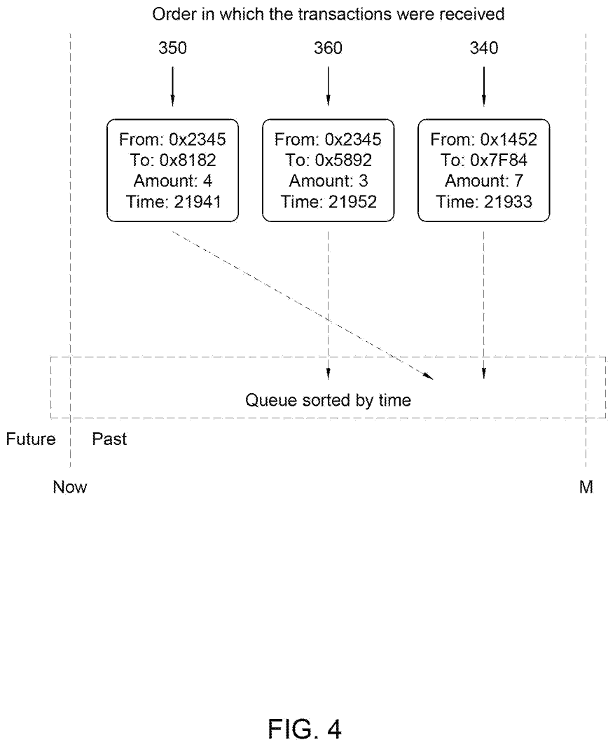

FIG. 4 pertains to steps 2 and 3 of the method in FIG. 1. Each computer inserts the transaction into a local waiting queue sorted by the associated timestamp. When the transaction age reaches a specified value and the transaction is not blocked by related transactions, processing continues. In this example, transaction 340 is received first, followed by transactions 360 and 350. The waiting queue order is 340, 350, and 360 based on their timestamps. Transactions 350 and 360 are related because they share at least one common address (0x2345). The age of a transaction is the current timestamp on the computer minus the transaction timestamp. When a transaction's age exceeds M and no related transaction precedes it, the computer continues processing. The invention applies even if the transaction lacks a timestamp and the network uses a method to assign a timestamp to it.

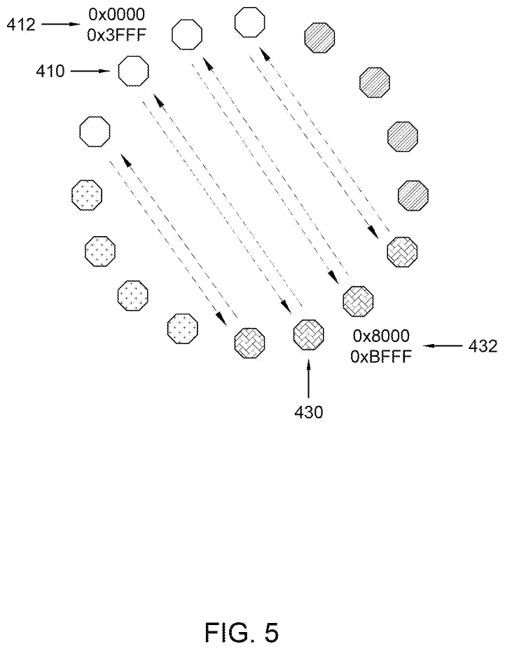

FIG. 5 corresponds to step 4 of the method in FIG. 1. Each computer processing the transaction sends local data to remote computers and collects needed data from remote computers. Computer 410 is depicted sending local data to computer 430 and receiving data from computer 430. Similarly, other computers exchange data with another computer in a different shard. The invention applies even if data is exchanged using other methods, such as gossip, and in cases where more shards are involved with computers exchanging data with other computers in each of the additional shards. In this example the committee consists of all computers storing any data involved in the transaction.

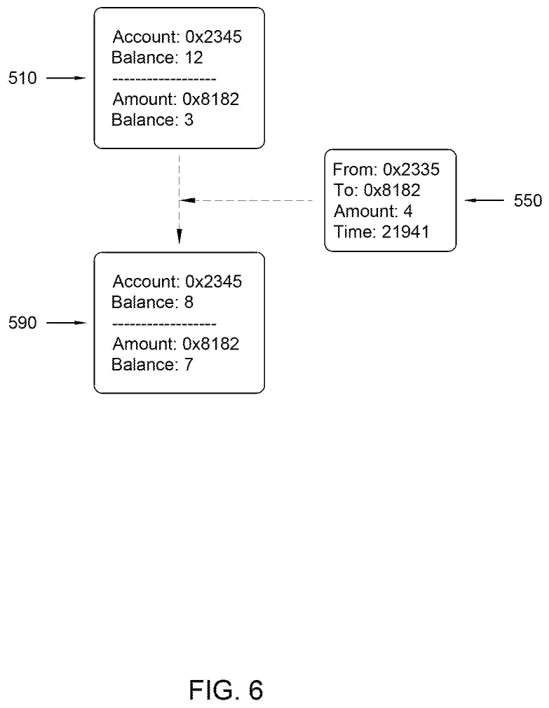

FIG. 6 pertains to step 5 of the method in FIG. 1. When all data required by the transaction is available locally, each computer executes the transaction to determine the new state, but does not save the new state to the storage device yet. In this example, the initial state 510 includes two accounts and their corresponding balances. Transaction 550 is executed against this initial state 510, producing the final state 590, which is not saved to the storage device yet.

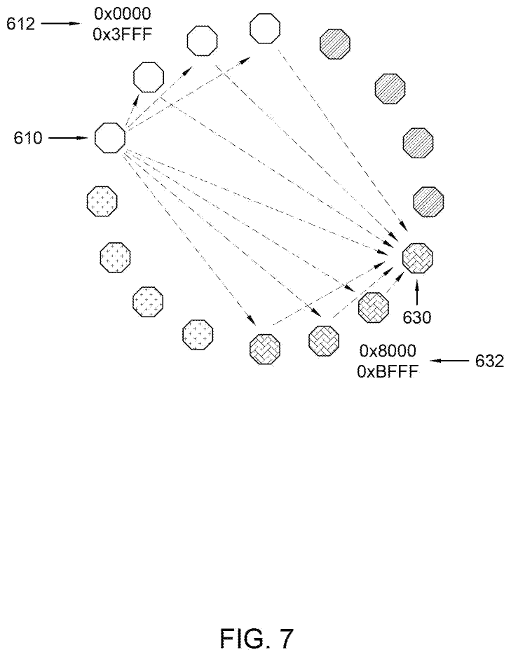

FIG. 7 relates to steps 6 and 7 of the method of FIG. 1. Each computer sends a vote message to other computers processing the transaction, informing them of the computed new state. Each computer collects votes from other computers to produce a receipt showing the resulting state accepted by a specified portion of computers. Computer 610 sends a vote message to all other computers storing data involved in the transaction, while computer 630 receives vote messages from all other computers processing the transaction to produce a receipt. A receipt is valid if more than a specified portion of voting computers have voted for the same result. The invention applies even if other methods, such as gossip, are used to distribute vote messages to other computers, and if a smaller subset of computers are allowed to vote.

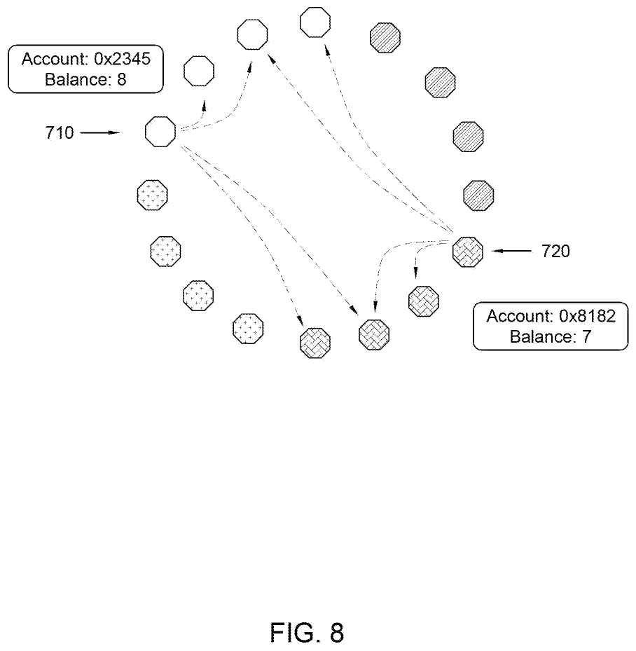

FIG. 8 corresponds to step 8 of the method of FIG. 1. The figure shows two computers 710 and 720, of the many computers involved in processing the transaction gossiping a receipt to other computers. Although not explicitly shown in this figure, the other computers involved with processing the transaction also gossip the receipt to other computers. The computers also commit to the transaction by updating the data of the accounts which are local to the computer. Although shown only for two of the many computers, the other computers involved with processing the transaction also update the account data which are local to the computer.

The embodiments described above are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

1. A method for processing transactions in a sharded distributed ledger system employing a network of peer-to-peer computers and using a communication protocol, comprising:
receiving, at one or more computer(s) without a leader in the network, a transaction from a user;
routing the transaction using a communication protocol to all computers storing data involved in the transaction to process the transaction independently without aggregating it into a block or other data structure;
inserting the transaction based on a sorting criteria into a local data structure implemented in a storage device associated with each computer storing data involved in the transaction;
waiting before processing the transaction further on each computer storing data involved in the transaction until the transaction meets a specified condition and all locks imposed by other transactions on local stored data accessed by the transaction are cleared;
locking, before the transaction is processed further, locally stored data accessed by the transaction at each computer storing data involved in the transaction;
sending, via a communication protocol, the locally stored data needed to process the transaction on each computer storing data involved in the transaction to a committee of corresponding computers selected via a one to one mapping between computers in different shards encompassing a subset of computers in the network;
executing the transaction on each computer in the committee to determine a new state for the locally stored data and creating a message to vote for the new state;
sending, via a communication protocol, a vote message from each computer in the committee to other computers in the committee;
receiving, via a communication protocol, at each computer in the committee, vote messages from other computers in the committee;
aggregating, at each computer in the committee, the received vote messages to produce a receipt reflecting the new state accepted by a specified portion of computers in the committee;
sending, via a communication protocol, a receipt message from each computer in the committee to each computer storing data involved in the transaction;
updating, at each computer storing data involved in the transaction, the locally stored data based on the new state specified in the receipt;
removing the transaction from a local data structure implemented in a storage device associated with each computer storing data involved in the transaction;
clearing all locks on the locally stored data accessed by the transaction, at each computer storing data involved in the transaction.

2. The method of claim 1, wherein the communication protocol is a gossip protocol.

3. The method of claim 1, wherein the communication protocol is a broadcast protocol.

4. The method of claim 1, wherein the communication protocol is a direct message transfer protocol.

5. The method of claim 1, wherein the sorting criteria is the timestamp associated with the transaction.

6. The method of claim 1, wherein the sorting criteria is a fee associated with the transaction.

7. The method of claim 1, wherein the sorting criteria is the proof-of-work associated with the transaction.

8. The method of claim 1, wherein the transactions are processed in order based on the sorting criteria.

9. The method of claim 1, wherein the data structure is a sorted array or a sorted tree.

10. The method of claim 1, wherein the specified condition for processing the transaction further is the transaction age reaching a specified value.

11. The method of claim 1, wherein the committee of computers is a subset of the computers storing data involved in the transaction.

12. The method of claim 1, wherein the committee of computers includes all computers storing data involved in the transaction.

13. The method of claim 1, wherein a specified portion is a percentage of computers greater than 50%.

14. The method of claim 1, wherein the storage device is a volatile memory or a persistent disk associated with the computer.

15. A sharded distributed ledger system, comprising:
a network of peer-to-peer computers;
each computer having local storage;
each computer storing a subset of a complete data set;
shards being defined as the subset of computers that store the same data;
each computer having the means for processing transactions;
each computer employing the method of claim 1 to process transactions.

16. The system of claim 15, wherein the sharded distributed ledger is composed of a different number of computers.

17. The system of claim 15, wherein the sharded distributed ledger is composed of a different number of shards.

18. The system of claim 15, wherein the sharded distributed ledger is composed of a different number of computers per shard.

19. The system of claim 15, wherein the sharded distributed ledger is composed of shards where the shard boundaries overlap and some computers belong to multiple shards.
